(19) United States
(12) Patent Application Publication
(10) Pub. No.: US 2004/0039708 A1
(43) Pub. Date: Feb. 26, 2004

(54) Electronic seal, IC card, authentication system using the same, and mobile device including such electronic seal

(76) Inventors: Xiaomang Zhang, Tenri-shi (JP); Teruaki Morita, Kitakatsuragigun (JP); Masayuki Ehiro, Osaka (JP)

Correspondence Address: HARNESS, DICKEY & PIERCE, P.L.C., P.O. BOX 8910, RESTON, VA, 20195, US

(21) Appl. No.: 10/631,813

(22) Filed: Aug. 1, 2003

(30) Foreign Application Priority Data
Aug. 2, 2002 (JP) 2002-225590

(51) Int. Cl. H04K 1/00; H04L 9/00; G06F 17/60

(52) U.S. Cl. 705/67

(57) ABSTRACT

An electronic seal includes an input section for inputting a random number encrypted based on a prescribed key; a secret key memory section for storing a secret key related to the prescribed key; a decoding section for decoding the input random number based on the secret key; an encryption section for encrypting the decoded random number based on the secret key; and an output section for outputting the random number encrypted based on the secret key.

### BACKGROUND OF THE INVENTION

1. Field of the Invention

The present invention relates to an electronic seal and an IC card used for, for example, over-the-counter services at municipal offices and in electronic commerce for authentication, an authentication system using the same, and a mobile device including such an electronic seal.

2. Description of the Related Art

Conventionally, authentication is performed for over-the-counter services at municipal offices and commercial transactions by use of seal (traditional seal). When a seal is stolen, or lost for some other reason, the user can easily notice such loss and can prepare countermeasures against any possible damage.

Recently, information in the form of electronic data (digital data) has been used in, for example, IC cards, ID cards, electronic commerce and encrypted electronic mail. This causes methods of authentication to be changed.

IC cards, ID cards, electronic commerce and encrypted electronic mail are demanded to have a very high security level, but in actuality, a very low level of security means is used such as, for example, a four-digit password.

For example, IC cards used as electronic wallets (also referred to as “smart cards”) are available as credit cards or cash cards. When a credit card is used, authentication is performed by two factors of (i) security check by the IC card and (ii) visual confirmation of the signature. When a cash card is used, authentication is performed by two factors of (i) security check by the IC card and (ii) confirmation of input of the password.

However, it is not easy to visually identify a false signature, and a four-digit password has a low security level. An increase in number of digits for improving the security level puts a burden on the user.

The security level of an IC card can be increased by performing authentication based on the user's inherent information, for example, signature, fingerprint, voiceprint, retina pattern, and face. However, in consideration of the software aspect such as the algorithm, hardware aspect such as the apparatus, and management aspect such as operation by the user, it is not easy to actually use such a method of authentication.

Mainly in the U.S. and Europe, IC cards are used for billing cellular phones, cable TV services, and the like. The security is checked using a PIN provided to the user. This also has the same security problem as the password.

ID cards used for entering and exiting from a building or a room are widely used. However, an ID card is the only means for authentication and therefore can be easily abused when stolen or lost.

The security level of electronic commerce relies on a special web browser, which has a certificate which has been issued by an authority. A password is required to use the special web browser, but once the password leaks, anybody can access the special web browser regardless of the security level in the special web browser.

Regarding encrypted electronic mail, keys for encryption and the like are managed by a computer. Therefore, anybody who uses the computer can freely read or write mail.

FIG. 10 is a block diagram illustrating an example of a conventional authentication system.

Referring to FIG. 10, an authentication system 110 includes a remote server 111 for storing card-related contents as backup, an IC card 112 having related information, security processing information and password checking information stored thereon, a host computer 113 for performing various types of processing, for example, service type display processing, selection execution processing, security processing, and password input processing, and a card reader/writer 114 for acting as a communication interface between the IC card 112 and the host computer 113 or for supplying power to the IC card 112 by electromagnetic induction when the IC card 112 is of a non-contact type. The authentication system 110 performs authentication when an IC card is used as a cash card.

The remote server 111 has information regarding the IC card 112 stored thereon as backup. In order to access the remote server 111, real-time communication is required. Therefore, authentication is performed between the IC card 112 and the host computer 113, and between the user and the host computer 113.

The IC card 112 and the host computer 113 have a security function. Where the IC card 112 is of a contact type, data communication is performed for mutual security checks between the IC card 112 and the host computer 113 via the card reader/writer 114 acting as an interface.

Where the IC card 112 is of a non-contact type, power is supplied from the card reader/writer 114 to the IC card 112 by electromagnetic induction, and data communication is performed for mutual security checks between the IC card 112 and the host computer 113.

When the host computer 113 confirms that the IC card 112 is authentic, a password input screen is displayed on a display of the host computer 113.

Next, when the user inputs a prescribed password via an input device 115, the password is supplied to the IC card 112 via the host computer 113 and the card reader/writer 114. The password is checked inside the IC card 112. When the authenticity of the user is confirmed as a result of the checking, the user is allowed to use the IC card 112. Services are then displayed on a display of the host computer 113. When a type of service is selected by the user, the service is executed by the host computer 113.

As described above, regarding use of IC cards, ID cards and the like, authenticity of the cards themselves is regarded as being important, and authentication of the users is performed using signatures and passwords as assisting factors. The security level of the authentication varies depending on the purpose of use of the card. At a low security level, the authenticity of the user may be confirmed only by the card itself. Since signatures can be imitated and four-digit numerical figures are used as passwords, a higher security level needs to be provided.

Methods of improving the security level by increasing the number of digits of the password data or using the user's inherent information such as, for example, signature, fingerprint, voiceprint, retina pattern and face are not easily implemented for reasons such as societal customs, difficulty for users, and technological problems.

Similar problems occur for electronic commerce and encrypted electronic mail since authenticity of the web browsers themselves is regarded as important.

### SUMMARY OF THE INVENTION

According to one aspect of the invention, an electronic seal includes an input section for inputting a random number encrypted based on a prescribed key; a secret key memory section for storing a secret key related to the prescribed key; a decoding section for decoding the input random number based on the secret key; an encryption section for encrypting the decoded random number based on the secret key; and an output section for outputting the random number encrypted based on the secret key.

In one embodiment of the invention, when the input section inputs a first response request ID encrypted based on the prescribed key, the decoding section decodes the input first response request ID based on the secret key. The electronic seal further includes a response request ID memory section for storing a second response request ID, and a comparison section for comparing the decoded first response request ID and the second response request ID. When the decoded first response request ID matches the second response request ID, the encryption section encrypts the decoded random number.

In one embodiment of the invention, the secret key memory section stores a plurality of secret keys respectively corresponding to a plurality of card company ID numbers. When the input section inputs a card company ID number, the secret key memory section specifies the secret key corresponding to the input card company ID number among the plurality of secret keys.

In one embodiment of the invention, the prescribed key is a public key, and the secret key and the public key form a key pair via a prescribed function.

According to another aspect of the invention, a mobile device including the above-described electronic seal is provided.

According to still another aspect of the invention, an IC card includes a random number generation section for generating a random number; a prescribed key memory section for storing a prescribed key; an encryption section for encrypting the generated random number based on the prescribed key; an output section for outputting the random number encrypted based on the prescribed key; an input section for inputting a random number encrypted based on a secret key related to the prescribed key; a decoding section for decoding the input random number based on the prescribed key; and a comparison section for comparing the random number generated by the random number generation section and the decoded random number.

In one embodiment of the invention, the IC card further includes an authentication section for, when the random number generated by the random number generation section matches the decoded random number, authenticating the user; and when the random number generated by the random number generation section does not match the decoded random number, rejecting the user.

In one embodiment of the invention, the IC card further includes a response request ID memory section for storing a response request ID. The encryption section encrypts the response request ID based on the prescribed key. The output section outputs the encrypted response request ID.

In one embodiment of the invention, the IC card further includes a card company ID number memory section for storing a card company ID number. The output section outputs the card company ID number.

In one embodiment of the invention, the prescribed key memory section stores a plurality of prescribed keys respectively corresponding to a plurality of card company ID numbers.

In one embodiment of the invention, the prescribed key is a public key, and the secret key and the public key form a key pair via a prescribed function.

According to still another aspect of the invention, an authentication system includes an IC card and an electronic seal. The IC card includes a random number generation section for generating a random number, a prescribed key memory section for storing a prescribed key, a first encryption section for encrypting the generated random number based on the prescribed key, and a first output section for outputting the random number encrypted based on the prescribed key. The electronic seal includes a second input section for inputting the random number encrypted based on the prescribed key, a secret key memory section for storing a secret key related to the prescribed key, a second decoding section for decoding, based on the secret key, the random number encrypted based on the prescribed key, a second encryption section for encrypting, based on the secret key, the random number decoded based on the secret key, and a second output section for outputting the random number encrypted based on the secret key. The IC card further includes a first input section for inputting the random number encrypted based on the secret key, a first decoding section for decoding, based on the prescribed key, the random number encrypted based on the secret key, and a comparison section for comparing the random number generated by the random number generation section and the random number decoded based on the prescribed key. The IC card and the electronic seal mutually exchange data for performing authentication.

In one embodiment of the invention, the IC card further includes an authentication section for, when the random number generated by the random number generation section matches the random number decoded based on the prescribed key, authenticating the user; and when the random number generated by the random number generation section does not match the random number decoded based on the prescribed key, rejecting the user.

In one embodiment of the invention, the prescribed key is a public key, and the secret key and the public key form a key pair via a prescribed function.

According to still another aspect of the invention, an electronic seal includes an input section for inputting a random number encrypted based on a prescribed key; a secret key memory section for storing a secret key related to the prescribed key; a decoding section for decoding the input random number based on the secret key; a user's inherent information memory section for storing a user's inherent information; a hash operation section for performing a hash operation using the decoded random number and the user's inherent information so as to output a hash operation result; an encryption section for encrypting the hash operation result based on the secret key; and an output section for outputting the encrypted hash operation result.

In one embodiment of the invention, when the input section inputs a first response request ID encrypted based on the prescribed key, the decoding section decodes the input first response request ID based on the secret key. The electronic seal further includes a response request ID memory section for storing a second response request ID, and a comparison section for comparing the decoded first response request ID and the second response request ID. When the decoded first response request ID matches the second response request ID, the encryption section encrypts the hash operation result.

In one embodiment of the invention, the secret key memory section stores a plurality of secret keys respectively corresponding to a plurality of card company ID numbers. The input section inputs a card company ID number, the secret key memory section specifies the secret key corresponding to the input card company ID number among the plurality of secret keys.

In one embodiment of the invention, the prescribed key is a public key, and the secret key and the public key form a key pair via a prescribed function.

According to still another aspect of the invention, a mobile device including the above-described electronic seal is provided.

According to still another aspect of the invention, an IC card includes a random number generation section for generating a random number; a prescribed key memory section for storing a prescribed key; an encryption section for encrypting the generated random number based on the prescribed key; an output section for outputting the encrypted random number; a user's inherent information memory section for storing user's inherent information; a hash operation section for performing a hash operation using the generated random number and the user's inherent information so as to output a first hash operation result; an input section for inputting a second hash operation result encrypted based on a secret key related to the prescribed key; a decoding section for decoding the input second hash operation result based on the prescribed key; and a comparison section for comparing the first hash operation result output from the hash operation section and the decoded second hash operation result.

In one embodiment of the invention, the IC card further includes an authentication section for, when the first hash operation result output from the hash operation section matches the decoded second hash operation result, authenticating the user; and when the first hash operation result output from the hash operation section does not match the decoded second hash operation result, rejecting the user.

In one embodiment of the invention, the IC card further includes a response request ID memory section for storing a response request ID. The encryption section encrypts the response request ID based on the prescribed key. The output section outputs the encrypted response request ID.

In one embodiment of the invention, the IC card further includes a card company ID number memory section for storing a card company ID number, wherein the output section outputs the card company ID number.

In one embodiment of the invention, the prescribed key memory section stores a plurality of prescribed keys respectively corresponding to a plurality of card company ID numbers.

In one embodiment of the invention, the prescribed key is a public key, and the secret key and the public key form a key pair via a prescribed function.

According to still another aspect of the invention, an authentication system includes an IC card and an electronic seal. The IC card includes a random number generation section for generating a random number, a prescribed key memory section for storing a prescribed key, a first encryption section for encrypting the generated random number based on the prescribed key, a first output section for outputting the encrypted random number, a first user's inherent information memory section for storing a user's inherent information, and a first hash operation section for performing a hash operation using the user's inherent information stored in the first user's inherent information memory section and the generated random number so as to output a first hash operation result. The electronic seal includes a second input section for inputting the encrypted random number, a secret key memory section for storing a secret key related to the prescribed key, a second decoding section for decoding, based on the secret key, the encrypted random number, a second user's inherent information memory section for storing user's inherent information, a second hash operation section for performing a hash operation using the user's inherent information stored in the second user's inherent information memory section and the decoded random number so as to output a second hash operation result, a second encryption section for encrypting the second hash operation result based on the secret key, and a second output section for outputting the encrypted second hash operation result. The IC card further includes a first input section for inputting the encrypted second hash operation result, a first decoding section for decoding, based on the prescribed key, the encrypted second hash operation result, a comparison section for comparing the first hash operation result and the decoded second hash operation result; and the IC card and the electronic seal mutually exchange data for performing authentication.

In one embodiment of the invention, the IC card further includes an authentication section for, when the first hash operation result matches the decoded second hash operation result, authenticating the user; and when the first hash operation result does not match the decoded second hash operation result, rejecting the user.

In one embodiment of the invention, the prescribed key is a public key, and the secret key and the public key form a key pair via a prescribed function.

According to the present invention, an electronic seal for performing encryption and decryption based on a secret key is introduced in order to cope with authentication using an IC card or the like for the “digital-era”. Thus, the security level of authentication is improved without putting any burden on the user.

The secret key is confined in the electronic seal. Data for authentication of the user is sent or received using an encryption technology. Thus, access to the secret key from outside is prevented. Since the secret key is prevented from being stolen, the security level of authentication can be improved. In addition, it is not necessary for the user to memorize a password having a large number of digits.

For example, an IC card for performing encryption and decryption based on a public key as a prescribed key can be combined with an electronic seal for performing encryption and decryption based on a secret key of a key pair related to the prescribed key. Thus, authentication using the public key cryptosystem can be performed, as follows.

A random number generated by a random number generation section of the IC card is encrypted based on the public key, and sent to the electronic seal. The electronic seal decodes the received random number based on the secret key, encrypts the decoded random number based on the secret key, and sends the resultant random number to the IC card. The IC card decodes the received random number based on the public key. When the decoded random number matches the original random number generated by the random number generation section, the authenticity of the user is confirmed.

When the random number encrypted by the IC card based on the public key is sent to the electronic seal, the response request ID (identification) encrypted based on the public key is also sent. The electronic seal decodes the received response request ID based on the secret key. When the decoded response request ID matches the response request ID stored in the response request ID memory section, the electronic seal encrypts the decoded random number based on the secret key, and sends the resultant random number to the IC card. When the decoded response request ID does not match the response request ID stored in the response request ID memory section, the processing is terminated. Thus, the security level of authentication is further improved.

The public key can be widely used by card companies and the like. The secret key of the electronic seal is stored for each card company ID number. Thus, a specific secret key can be specified from the card company ID number to be used. An electronic seal according to the present invention can perform authentication using a secret key cryptosystem as well as a public key cryptosystem.

A user's inherent information such as a user's signature, fingerprint, voiceprint, retina pattern, photo of the user's face or the like can be made into the form of electronic data, and data can be input or output (sent or received; wireless or wired). Thus, the security level is further improved.

The electronic seal can be attached to, for example, fashion accessories such as rings, bracelets, earrings or the like, or glasses, which can be constantly worn by the user. Thus, the electronic seal is difficult to lose, and thus the security level of authentication is further improved. The electronic seal is easier to notice when stolen or lost, and thus measures against damage can be taken more quickly than when immaterial passwords are used.

Thus, the invention described herein makes possible the advantages of providing an electronic seal, an IC card, and an authentication system using the same for improving the security level of authentication without putting any burden on the user, and a mobile device including such an electronic seal.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating an authentication system according to a first example of the present invention;

FIG. 2 is a block diagram illustrating an IC card in the authentication system shown in FIG. 1;

FIG. 3 is a block diagram illustrating an electronic seal in the authentication system shown in FIG. 1;

FIG. 4 is a block diagram illustrating a card reader/writer in the authentication system shown in FIG. 1;

FIG. 5 is a flowchart illustrating an authentication procedure performed by the authentication system shown in FIG. 1;

FIG. 6A is a block diagram illustrating an authentication system according to a second example of the present invention;

FIG. 6B is a block diagram illustrating an IC card in the authentication system shown in FIG. 6A;

FIG. 7 is a block diagram illustrating an electronic seal in the authentication system shown in FIG. 6A;

FIG. 8 is a flowchart illustrating an authentication procedure performed by the authentication system shown in FIG. 6A;

FIG. 9 shows various fields to which an electronic seal according to the present invention is applicable; and

FIG. 10 is a block diagram illustrating an example of a conventional authentication system.

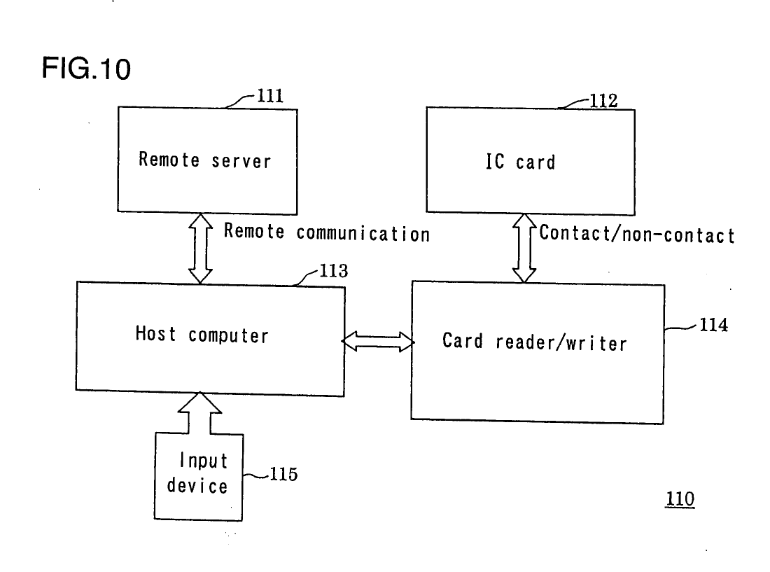

### DESCRIPTION OF THE PREFERRED EMBODIMENTS

Hereinafter, the present invention will be described by way of illustrative examples with reference to the accompanying drawings.

### Example 1

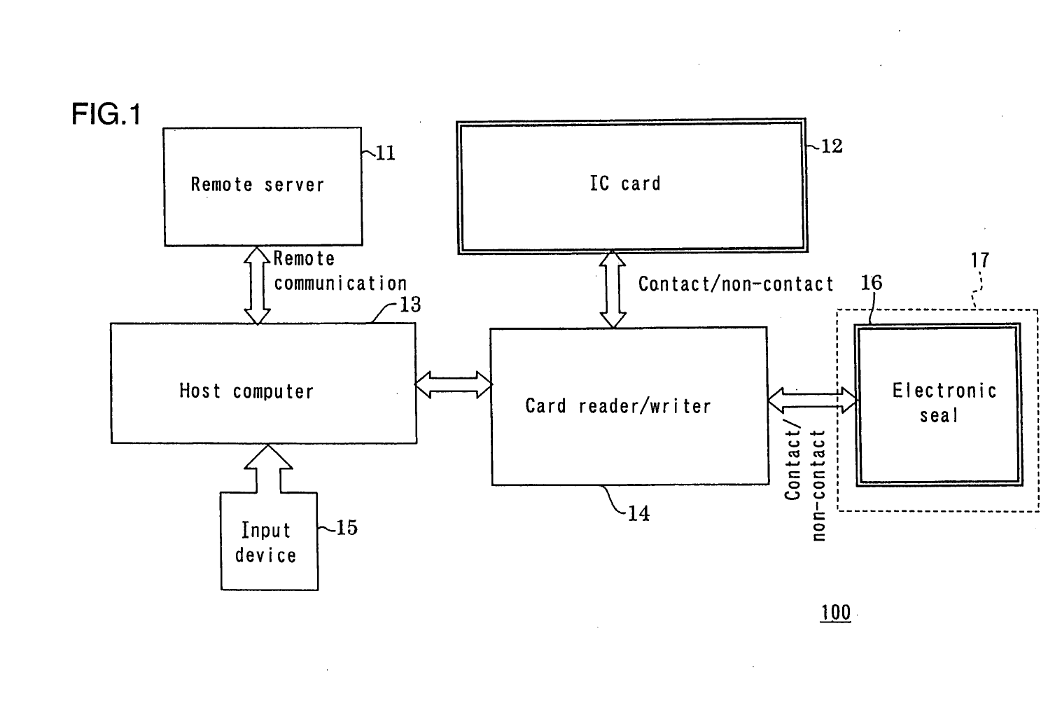

FIG. 1 is a block diagram illustrating an authentication system 100 according to a first example of the present invention.

Referring to FIG. 1, an authentication system 100 includes a remote server 11 for storing card-related contents as backup, an IC card 12 having encryption and encoding functions using a public key and having related information and security processing information stored therein, a host computer 13 for performing various types of processing, for example, service type display processing, selection execution processing, security processing, and password input processing, a card reader/writer 14 for acting as a communication interface between the IC card 12 and the host computer 13 or for supplying power to the IC card 12 when the IC card 12 is of a non-contact type, and an electronic seal 16 having encryption and encoding functions with a secret key. The electronic seal 16 is mounted on, for example, a mobile device 17. In this specification, the term “mobiledevice” includes wearable elements such as rings, glasses, earrings, bracelets and the like.

The remote server 11 has information regarding the IC card 12 stored thereon as backup. In order to access the remote server 11, real-time communication is required. Therefore, authentication is performed between the IC card 12, the host computer 13, and the electronic seal 16.

The IC card 12 and the host computer 13 have a security function. Where the IC card 12 is of a contact type, data communication is performed for mutual security checks between the IC card 12 and the host computer 13 via the card reader/writer 14 acting as an interface.

Where the IC card 12 is of anon-contact type, power is supplied from the card reader/writer 14 to the IC card 12, and data communication is performed for mutual security checks between the IC card 12 and the host computer 13.

When the host computer 13 and the IC card 12 confirm authenticity of each other, authentication of the user is performed using the public key cryptosystem by the IC card 12 and the electronic seal 16. When the authenticity of the user is confirmed, the user is allowed to use the IC card 12. Services are displayed on a display of the host computer 13. When a type of service is selected by the user via an input device 15, the service is executed by the host computer 13. This will be described in more detail later.

In order to further raise the security level, authentication may be performed by having the user input his/her password to the host computer 13 via the input device 15, in addition to the above. In this case, the input password is supplied to the IC card 12 via the card reader/writer 14. The password is checked inside the IC card 12. When the authenticity of the user is confirmed as a result of the checking, the user is allowed to use the IC card 12.

The secret key included in the electronic seal 16 is related to the public key. The secret key and the public key form a key pair via a prescribed function.

In the case of, for example, the RSA system which is widely used as an algorithm of a public key encryption (described below), the key pair of the public key (hereinafter, represented by the reference Kp) and the secret key (hereinafter, represented by the reference Ks) is determined as follows.

First, two prime numbers P and Q are selected. Here, the term “prime number” refers to an integer which is not divisible by any other number except for that number itself and 1. “Prime numbers” are, for example, 2, 3, 5, 7, 11, . . . .

Then, value E corresponding to the public key Kp is determined, and value D corresponding to the secret key Ks is obtained by

(D×E)%N1=1 Expression 1

N1=(P−1)×(Q−1).

The left term of expression 1 is the remainder obtained when (D×E) is divided by N1. Value D is obtained from the left term of expression 1 so as to fulfill the value of the right term of expression 1 (=1).

Thus, the public key Kp=(E, N) and the secret key Ks=(D, N) are obtained. Here, N is obtained by N=P×Q.

The public key Kp is advantageously used freely by related organizations such as card companies and the like. The secret key Ks is confined in the electronic seal 16 and is inaccessible. Thus, the security level can be increased.

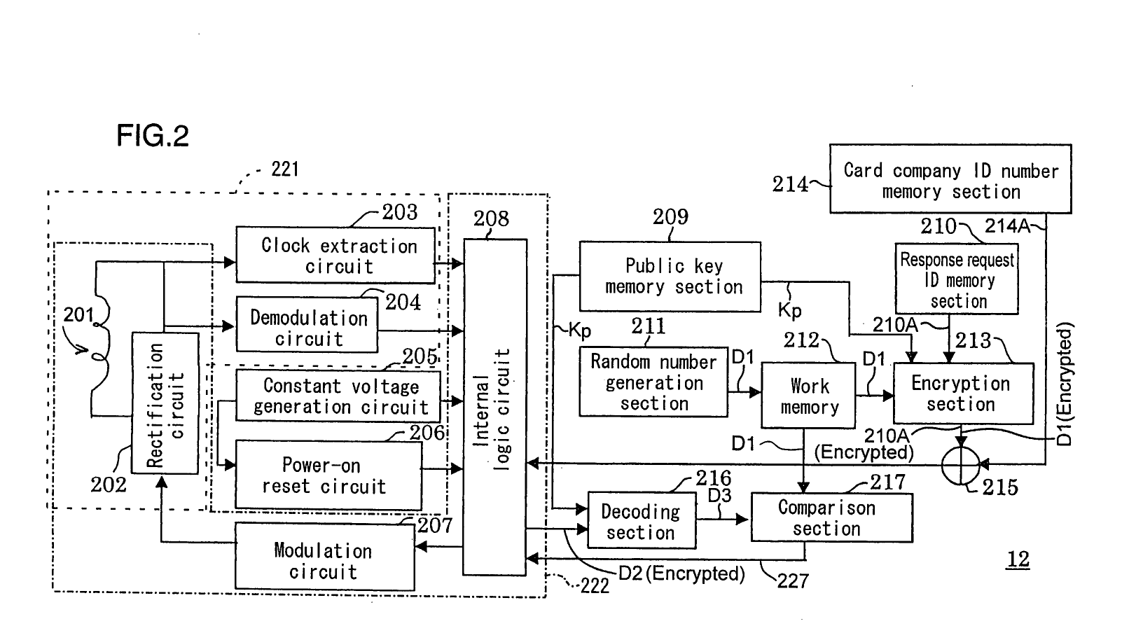

FIG. 2isablockdiagramillustratingastructure of the IC card 12 shown in FIG. 1.

Referring to FIG. 2, the IC card 12 includes an antenna circuit 201, a rectification circuit 202, a clock extraction circuit 203, a demodulation circuit 204, a constant voltage generation circuit 205, a power-on reset circuit 206, a modulation circuit 207, an internal logic circuit 208 having an authentication function, a public key memory section 209 which is a prescribed key memory section, a response request ID memory section 210, a random number generation section 211, a work memory 212, an encryption section 213, a card company ID number memory section 214, a synthesis section 215, a decoding section 216, and a comparison section 217.

The antenna circuit 201, the rectification circuit 202, the clock extraction circuit 203, and the demodulation circuit 204 are included in an input section 221 (in FIG. 2, the input section 221 is a receiving section but may be a contact section with the card reader/writer 14). The antenna circuit 201, the rectification circuit 202, the modulation circuit 207, and the internal logic circuit 208 are included in an output section 222 (in FIG. 2, the output section 222 is a sending section but may be a contact section with the card reader/writer 14). The input section 221 and the output section 222 may include a separate antenna circuit and a separate rectification circuit.

The antenna circuit 201 is a sending/receiving section, and receives signals from the card reader/writer 14 and also sends signals from the IC card 12 to the card reader/writer 14.

The rectification circuit 202 rectifies a signal received via the antenna circuit 201 and outputs the rectified signal to the clock extraction circuit 203 and the demodulation circuit 204. The rectification circuit 202 also rectifies a signal from the modulation circuit 207 and outputs the rectified signal to the antenna circuit 201.

The clock extraction circuit 203 extracts a clock signal required for an operation of the internal logic circuit 208 and the like from a carrier wave from the card reader/writer 14 received via the antenna circuit 201, and outputs the clock signal to the internal logic circuit 208.

The demodulation circuit 204 demodulates the signal from the card reader/writer 14 received via the antenna circuit 201 and outputs the demodulated signal to the internal logic circuit 208.

The constant voltage generation circuit 205 outputs a constant voltage to the power-on reset circuit 206 and the internal logic circuit 208.

The power-on reset circuit 206 controls power shutoff/reset of the IC card 12, and outputs a control signal for power shutoff/reset to the internal logic circuit 208.

The modulation circuit 207 modulates a prescribed carrier wave so as to have an arbitrary wavelength based on the control by the internal logic circuit 208, and sends the obtained carrier wave to the card reader/writer 14 via the antenna circuit 201.

The internal logic circuit 208 includes a CPU (central processing unit), a memory including a ROM and RAM, and the like, and controls each of the elements of the IC card 12. The internal logic circuit 208 also receives a comparison result 227 of the comparison section 217 and authenticates or rejects the user based on the comparison result 227.

The structure of the IC card 12 including the circuits 201 through 207 is an exemplary structure in the case where the card reader/writer 14 communicates with the IC card 12 in a non-contact manner. The present invention is not limited to this structure. Other structures may be adopted in the case where the card reader/writer 14 communicates with the IC card 12 in a contact manner. The sections 209 through 217 are common to the IC card 12 of the contact type and the IC card 12 of the non-contact type.

The public key memory section 209 has a plurality of public keys Kp stored thereon. The plurality of public keys Kp are a plurality of prescribed keys respectively corresponding to a plurality of card company ID numbers. The prescribed keys are the public keys Kp in this example, but may be secret keys.

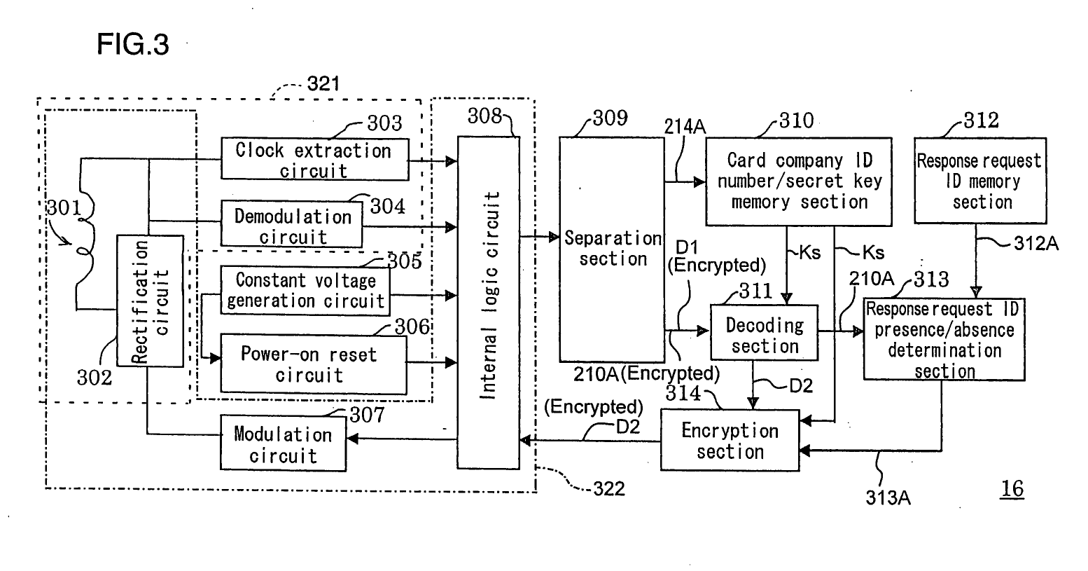

The response request ID memory section 210 has a response request ID 210A stored thereon for requesting a response from the electronic seal 16. The response request ID 210A is used for comparison with a response request ID 312A (FIG. 3) included in the electronic seal 16. When the response request ID 210A matches the response request ID 312A, the electronic seal 16 returns a signal to the IC card 12. The details will be described below.

The random number generation section 211 generates a random number D1.

The work memory 212 stores the random number D1 generated by the random number generation section 211.

The encryption section 213 encrypts the random number D1 stored in the work memory 212 and the response request ID 210A stored in the response request ID memory section 210 based on the public key Kp corresponding to each card company ID number.

The card company ID number memory section 214 has a card company ID number 214A of each card company stored thereon.

The synthesis section 215 synthesizes the card company ID number 214A, the encrypted response request ID 210A and the encrypted random number (encrypted D1). The synthesized value is sent from the internal logic circuit 208 to the card reader/writer 14 via the modulation circuit 207, the rectification circuit 202 and the antenna circuit 201.

An encrypted random number D2 which is sent from the card reader/writer 14 via the antenna circuit 201, the demodulation circuit 204 and the internal logic circuit 208 is decoded by the decoding section 216 into a random number D3 based on the public key Kp.

The comparison section 217 compares the random number D3 and the random number D1 generated by the random number generation section 211, and supplies the comparison result 227 to the internal logic circuit 208. The internal logic circuit 208 authenticates the user when the random numbers D1 and D3 match each other, and rejects the user when the random numbers D1 and D3 do not match each other.

FIG. 3 is a block diagram illustrating a structure of the electronic seal 16.

Referring to FIG. 3, the electronic seal 16 includes an antenna circuit 301, a rectification circuit 302, a clock extraction circuit 303, a demodulation circuit 304, a constant voltage generation circuit 305, a power-on reset circuit 306, a modulation circuit 307, an internal logic circuit 308, a separation section 309 for separating the card company ID number from other information data, a card company ID number/secret key memory section 310, a decoding section 311, a response request ID memory section 312, a response request ID presence/absence determination section 313 as a comparison section, and an encryption section 314.

The antenna circuit 301, the rectification circuit 302, the clock extraction circuit 303, and the demodulation circuit 304 are included in an input section 321 (in FIG. 3, the input section 321 is a receiving section but may be a contact section with the card reader/writer 14). The antenna circuit 301, the rectification circuit 302, the modulation circuit 307, and the internal logic circuit 308 are included in an output section 322 (in FIG. 3, the output section 322 is a sending section but may be a contact section with the card reader/writer 14). The input section 321 and the output section 322 may include a separate antenna circuit and a separate rectification circuit.

The antenna circuit 301 is a sending/receiving section, and receives signals from the card reader/writer 14 and also sends signals from the electronic seal 16 to the card reader/writer 14.

The rectification circuit 302 rectifies a signal received via the antenna circuit 301 and outputs the rectified signal to the clock extraction circuit 303 and the demodulation circuit 304. The rectification circuit 302 also rectifies a signal from the modulation circuit 307 and outputs the rectified signal to the antenna circuit 301.

The clock extraction circuit 303 extracts a clock signal required for an operation of the internal logic circuit 308 and the like from a carrier wave from the card reader/writer 14 received via the antenna circuit 301, and outputs the clock signal to the internal logic circuit 308.

The demodulation circuit 304 demodulates the signal from the card reader/writer 14 received via the antenna circuit 301 and outputs the demodulated signal to the internal logic circuit 308.

The constant voltage generation circuit 305 outputs a constant voltage to the power-on reset circuit 306 and the internal logic circuit 308.

The power-on reset circuit 306 controls power shutoff/reset of the electronic seal 16, and outputs a control signal for power shutoff/reset to the internal logic circuit 308.

The modulation circuit 307 modulates a prescribed carrier wave so as to have an arbitrary wavelength based on the control by the internal logic circuit 308, and sends the obtained carrier wave to the card reader/writer 14 via the antenna circuit 301.

The internal logic circuit 308 includes a CPU (central processing unit), a memory including a ROM and RAM, and the like, and controls each of the elements of the electronic seal 16.

The structure of the electronic seal 16 including the circuits 301 through 307 is an exemplary structure in the case where the card reader/writer 14 communicates with the electronic seal 16 in a non-contact manner. The present invention is not limited to this structure. Other structures may be adopted in the case where the card reader/writer 14 communicates with the electronic seal 16 in a contact manner. The sections 309 through 314 are common to the electronic seal 16 of the contact type and the electronic seal 16 of the non-contact type.

The separation section 309 separates the signal sent from the card reader/writer 14 via the antenna circuit 301, the rectification circuit 302, the demodulation circuit 304 and the internal logic circuit 308 into the card company ID number 214A and other information data (the response request ID 210A and the random number D1 which are encrypted based on the public key Kp).

The card company ID number/secret key memory section 310 has a plurality of secret keys Ks stored thereon respectively corresponding to the plurality of card company ID numbers. Upon receiving a card company ID number 214A from the separation section 309, the card company ID number/secret key memory section 310 specifies a secret key Ks corresponding to the card company ID number 214A from the plurality of secret keys Ks and supplies that secret key Ks to the decoding section 311.

The decoding section 311 receives the response request ID 210A and the random number Dl encrypted based on the public key Kp from the separation section 309, and decodes the request ID 210A and the random number Dl based on the secret key Ks supplied from the card company ID number/secret key memory section 310. The decoded random number D1 is referred to as a “random number D2”.

The response request ID memory section 312 has a response request ID 312A to be compared with the received response request ID 210A.

The response request ID presence/absence determination section 313 compares the response request ID 210A decoded by the decoding section 311 and the response request ID 312A stored on the response request ID memory section 312. When the two IDs match each other, the response request ID presence/absence determination section 313 determines that the appropriate response request ID is present in the received signal. When the two IDs do not match each other, the response request ID presence/absence determination section 313 determines that the appropriate response request ID is absent from the received signal. In either case, the determination signal 313A is output to the encryption section 314.

When the determination signal is “YES” (i.e., when the appropriate response request ID is determined to be present), the encryption section 314 encrypts the random number D2 based on the secret key Ks output from the card company ID number/secret key memory section 310. When the determination signal is “NO” (i.e., when the appropriate response request ID is determined to be absent), the random number D2 is not encrypted by the encryption section 314, and the processing is terminated.

The electronic seal 16 is preferably included in the mobile device 17 (FIG. 1). Especially in order to prevent the electronic seal 16 from being lost, the electronic seal 16 is preferably attached to, for example, fashion accessories such as rings, bracelets, earrings or the like, or glasses, which can be constantly worn by the user.

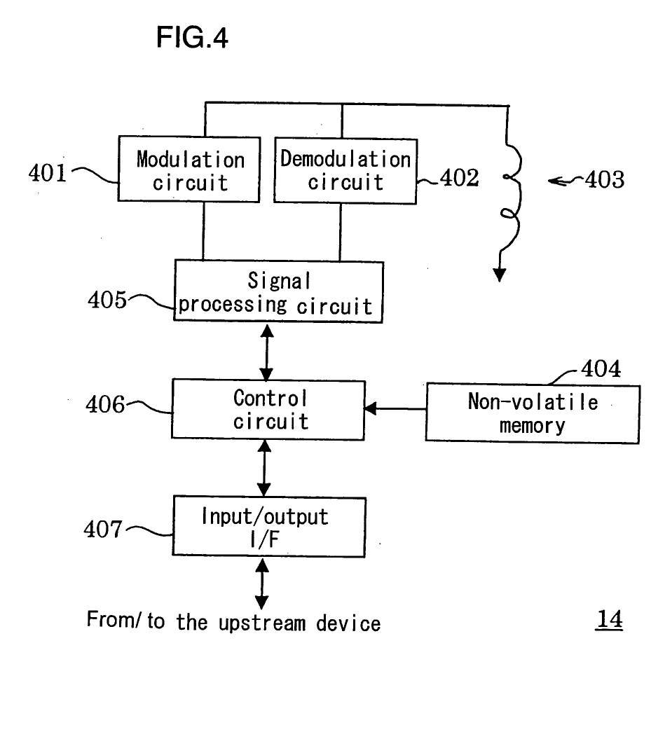

FIG. 4 is a block diagram illustrating a structure of the card reader/writer 14 shown in FIG. 1.

Referring to FIG. 4, the card reader/writer 14 includes a modulation circuit 401, a demodulation circuit 402, an antenna circuit 403, a non-volatile memory 404, a signal processing circuit 405, a control circuit 406, and an input/output I/F (interface) circuit 407.

The modulation circuit 401 modulates a signal from the signal processing circuit 405 so as to have a prescribed carrier wave and supplies the obtained carrier wave to the antenna circuit 403. For example, a carrier wave having a frequency of 13.56 MHz is sent by the antenna circuit 403 by the ASK (Amplitude Shift Keying) system.

The demodulation circuit 402 demodulates a prescribed carrier wave from the antenna circuit 403 and supplies the obtained carrier wave to the signal processing circuit 405.

The signal processing circuit 405 detects data input/output to and from the IC card 12 and the electronic seal 16 based on the control by the control circuit 406, and processes the signal received during data transmission.

The control circuit 406 includes a CPU, a memory and the like therein. The control circuit 406 reads and starts a control program pre-recorded in the non-volatile memory 404 so as to control each of the circuits included in the card reader/writer 14 and to perform data communication with an upstream device such as the host computer 13 or the like via the input/output I/F circuit 407.

Hereinafter, an authentication procedure performed by the authentication system 100 of the first example using the public key cryptosystem will be described.

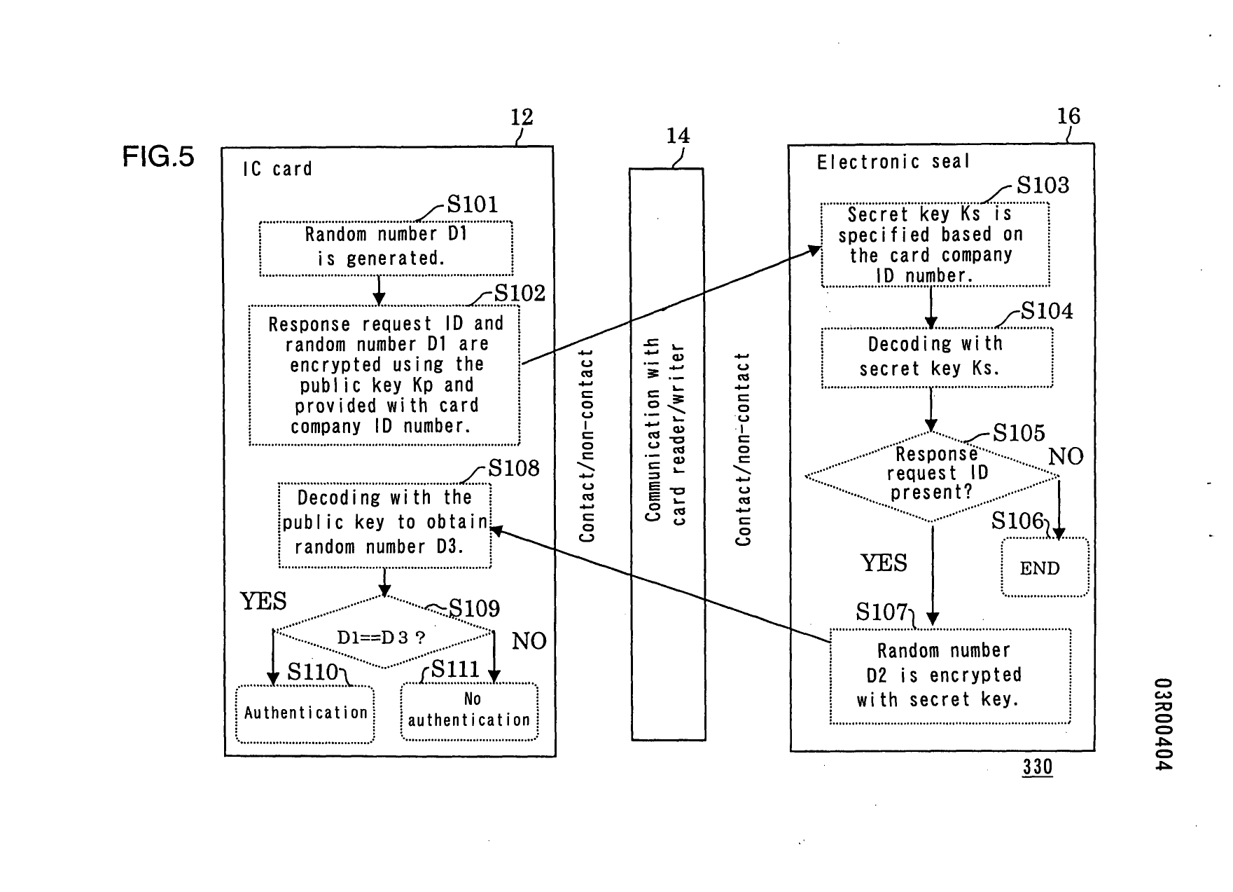

FIG. 5 is a flowchart 330 illustrating the authentication procedure performed by the authentication system 100. FIG. 5 also shows which steps are performed by which parts of the authentication system 100, i.e., the IC card 12, the card reader/writer 14 or the electronic seal 16.

As shown in FIG. 5, in step S101, the IC card 12 randomly generates a random number Dl by the random number generation section 211.

Then, in step S102, the encryption section 213 encrypts the generated random number Dl and the response request ID210A based on the public key Kp. The card company ID number 214A, the random number Dl encrypted based on the public key Kp, and the response request ID210A encrypted based on the public key Kp are sent to the electronic seal 16 via the card reader/writer 14.

In step S103, the electronic seal 16 specifies the secret key Ks based on the received card company ID number 214A.

In step S104, the decoding section 311 decodes the encrypted random number Dl and the encrypted response request ID 210A based on the secret key Ks specified in step S103. Thus, the decoded response request ID 210A and the decoded random number D1 (i.e., D2) are obtained.

In step S105, the decoded response request ID 210A is compared with the response request ID 312A stored in the response request ID memory section 312 so as to determine whether or not the appropriate response request ID is present in the received signal. When the appropriate response request ID is determined to be absent (“NO”), the processing is terminated (step S106). When the appropriate response request ID is determined to be present (“YES”), the processing goes to step S107, where the encryption section 314 encrypts the random number D2 based on the secret key Ks specified in step S103. The encrypted random number (encrypted D2) is sent to the IC card 12.

In step S108, the IC card 12 decodes the received encrypted random number D2 based on the public key Kp, thereby obtaining the random number D3.

In step S109, the random number D1 generated in step S101 is compared with the random number D3 obtained in step S108. When the random numbers D1 and D3 match each other (“YES”), the processing goes to step S110, where the authenticity of the user is confirmed.

When the random numbers D1 and D3 do not match each other (“NO”) in step S109, the processing goes to step S111, where the authenticity of the user is rejected.

For authentication, it is more preferable that the number of digits (range) of the random number generated by the IC card 12 is longer for guaranteeing a sufficiently high security level. Authentication may be performed a plurality of times by sending and receiving data between the IC card 12 and the electronic seal 16. However, when the total number of returns from the electronic seal 16 exceeds a threshold level, there is a risk that the secret key may be decrypted, resulting in a reduction in the security level. Therefore, it is preferable to provide, in the electronic seal 16, a counter for storing the number of returns from the electronic seal 16. Thus, when the value of the counter exceeds the threshold level, appropriate means can be taken such that the key of the electronic seal 16 is changed. In order to prevent concentrated decipherment, which might allow leakage of the secret key, it is preferable to provide a counter for storing the number of returns during a preset short time period (a short period based on one cycle of authentication processing). Thus, when the value of the counter exceeds a preset maximum number, returns from the electronic seal 16 can be prohibited.

A default secret key can be stored in the card company ID number/secret key memory section 310 of the electronic seal 16. In the case where an expansion memory area is provided, a card company can have the card company ID number/secret key memory section 310 store its own ID number and a secret key corresponding to the ID number. In this case, the card company can select either the default secret key or its own key.

In the first example, authentication is performed by the electronic seal 16 and the IC card 12 using the public key system. The electronic seal 16 can cope with both the public key system and the secret key system. In the case of the secret key system, a device for communicating with the electronic seal 16 for authentication is provided with an encryption and decryption function.

In the first example, an electronic seal according to the present invention is used for improving the security level of an IC card which is used as a cash card or the like. The present invention is also applicable to improve the security level of electronic commerce, encrypted electronic mail or the like.

### Example 2

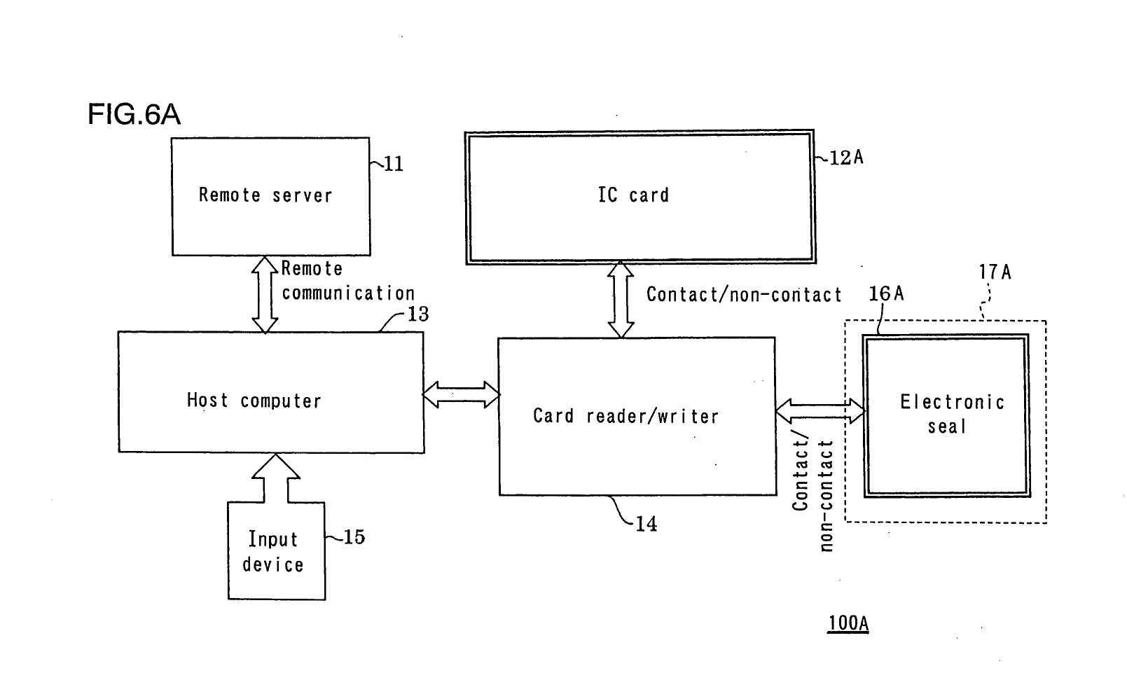

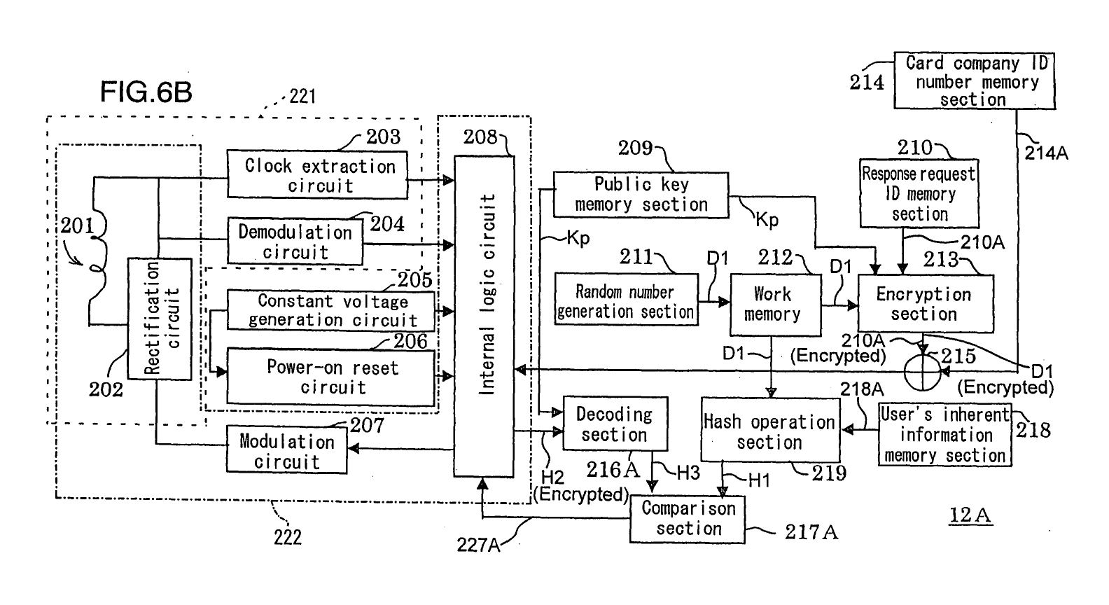

FIG. 6A is a block diagram illustrating an authentication system 100A according to a second example of the present invention. The authentication system 100A is different from the authentication system 100 shown in FIG. 1 in that the authentication system 100A includes an IC card 12A and an electronic seal 16A. The electronic seal 16A is mounted on, for example, a mobile device 17A. In other points, the authentication system 100A is identical to the authentication system 100, and detailed descriptions thereof will be omitted.

The IC card 12A and the electronic seal 16A have a user's inherent information stored thereon in addition to the information stored in the IC card 12 and the electronic seal 16 in order to further improve the security level than in that in the first example.

FIG. 6B is a block diagram illustrating a structure of the IC card 12A shown in FIG. 6A. Like reference numerals refer to like elements as those in FIG. 2 and detailed descriptions thereof will be omitted.

Referring to FIG. 6B, the IC card 12A includes an antenna circuit 201, a rectification circuit 202, a clock extraction circuit 203, a demodulation circuit 204, a constant voltage generation circuit 205, a power-on reset circuit 206, a modulation circuit 207, an internal logic circuit 208, a public key memory section 209, a response request ID memory section 210, a random number generation section 211, a work memory 212, an encryption section 213, a card company ID number memory section 214, a synthesis section 215, a decoding section 216A, a user's inherent information memory section 218, a hash operation section 219, and a comparison section 217A. The IC card 12A is different from the IC card 12 shown in FIG. 2 in the decoding section 216A, the user's inherent information memory section 218, the hash operation section 219, and the comparison section 217A.

The user's inherent information memory section 218 stores a user's inherent information 218A. User's inherent information can be, for example, a password, a user's signature, fingerprint, voiceprint, retina pattern, or a photo of the user's face.

The hash operation section 219 performs a hash operation on the random number D1 stored in the work memory 212 and the user's inherent information 218A stored in the user's inherent information memory section 218, and generates and outputs hash operation data H1.

The decoding section 216A decodes encrypted hash operation data H2 sent from the card reader/writer 14 via the antenna circuit 201, the rectification circuit 202, the demodulation circuit 204 and the internal logic circuit 208 based on a public key Kp. Thus, hash operation data H3 is obtained.

The comparison section 217A compares the hash operation data H3 with the hash operation data H1 obtained by the hash operation of the hash operation section 219, and supplies the comparison result 227A to the internal logic circuit 208.

When the hash operation data H3 matches the hash operation data H1, the internal logic circuit 208 authenticates the user. When the hash operation data H3 does not match the hash operation data H1, the internal logic circuit 208 rejects the user.

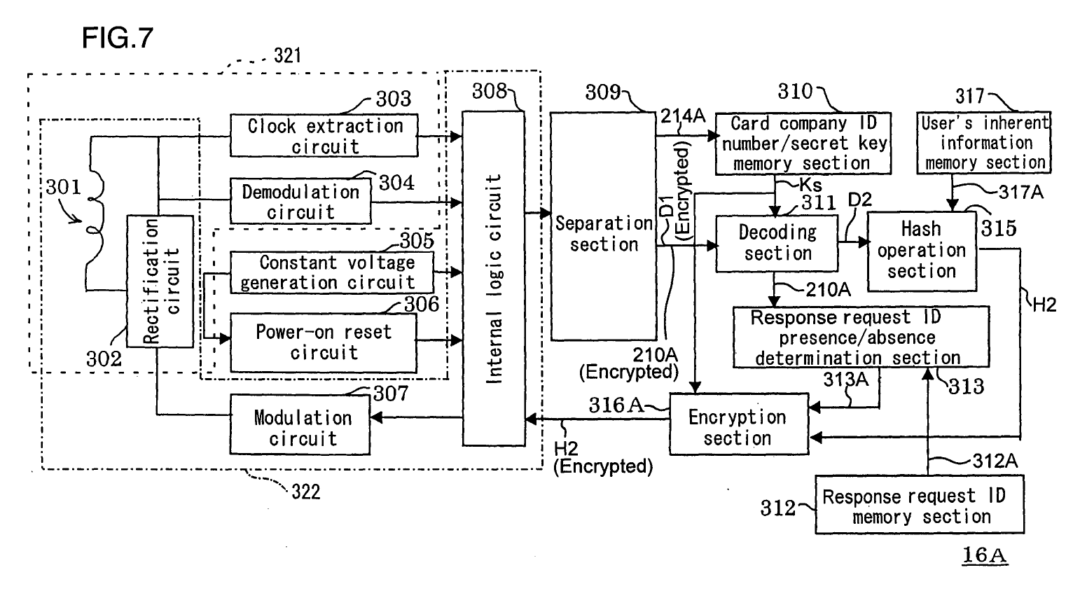

FIG. 7 is a block diagram illustrating a structure of the electronic seal 16A. Like reference numerals refer to like elements as those in FIG. 3 and detailed descriptions thereof will be omitted.

Referring to FIG. 7, the electronic seal 16A includes an antenna circuit 301, a rectification circuit 302, a clock extraction circuit 303, a demodulation circuit 304, a constant voltage generation circuit 305, a power-on reset circuit 306, a modulation circuit 307, an internal logic circuit 308, a separation section 309, a card company ID number/secret key memory section 310, a decoding section 311, a response request ID memory section 312, a response request ID presence/absence determination section 313, a user's inherent information memory section 317, a hash operation section 315, and an encryption section 316. The electronic seal 16A is different from the electronic seal 16 shown in FIG. 3 in the user's inherent information memory section 317, the hash operation section 315, and the encryption section 316A.

The user's inherent information memory section 317 stores a user's inherent information 317A. User's inherent information is, for example, password, user's signature, fingerprint, voiceprint, retina pattern, and photo of the user's face.

The hash operation section 315 performs a hash operation on the random number D2 and the user's inherent information 317A stored in the user's inherent information memory section 317, and generates and outputs hash operation data H2.

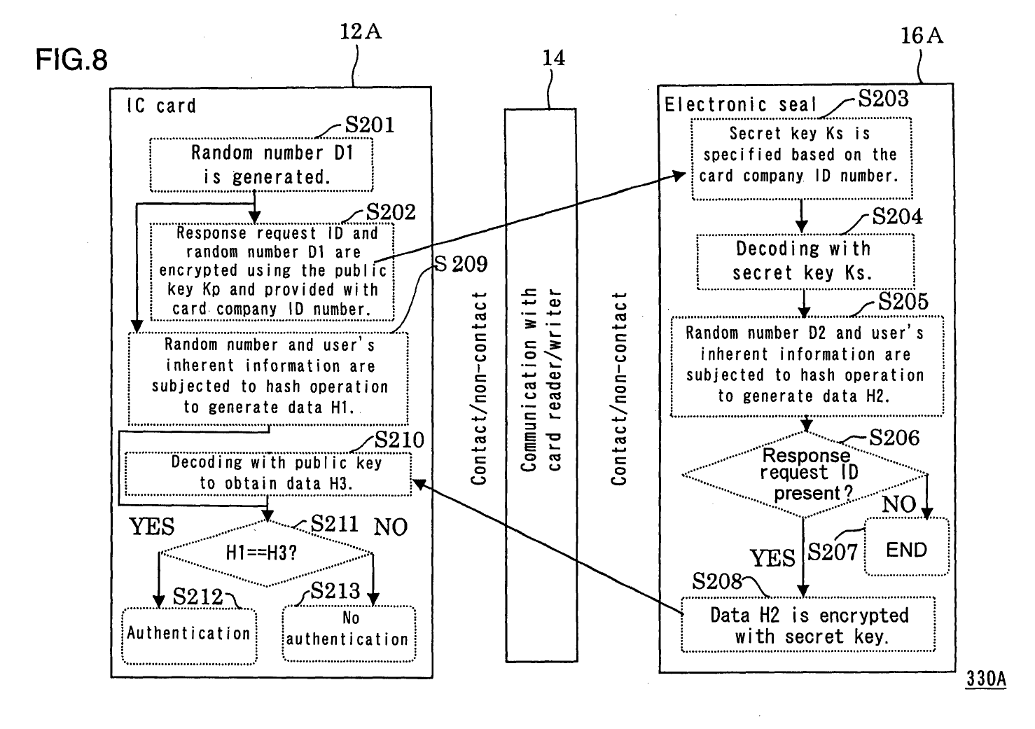

As described below with reference to FIG. 8, when the determination result of the response request ID presence/absence determination section 313 is “YES” (i.e., when the appropriate response request ID is determined to be present), the encryption section 316A encrypts the hash operation data H2 supplied from the hash operation section 315 based on a secret key Ks supplied from the card company ID number/secret key memory section 310. When the determination result is “NO” (i.e., when the appropriate response request ID is determined to be absent), the hash operation data H2 supplied from the hash operation section 315 is not encrypted and the processing is terminated.

The structure of the card reader/writer 14 in the second example is identical to that of the card reader/writer 14 in the first example, and the description thereof will be omitted.

FIG. 8 is a flowchart 330A illustrating the authentication procedure performed by the authentication system 100A.

As shown in FIG. 8, in step S201, the IC card 12A randomly generates a random number D1 by the random number generation section 211.

Then, in step S202, the encryption section 213 encrypts the generated random number D1 and the response request ID 210A based on the public key Kp. The card company ID number 214A, the random number Dl encrypted based on the public key Kp, and the response request ID210A encrypted based on the public key Kp are sent to the electronic seal 16A via the card reader/writer 14.

In step S203, the electronic seal 16A specifies the secret key Ks based on the received card company ID number 214A.

In step S204, the decoding section 311 decodes the encrypted random number D1 and the encrypted response request ID 210A based on a secret key Ks specified in step S203. Thus, the decoded response request ID 210A and the decoded random number D1 (i.e., D2) are obtained.

In step S205, the random number D2 and the user's inherent information 317A stored in the user's inherent information memory section 317 are subjected to a hash operation by the hash operation section 315. Thus, hash operation data H2 is generated.

In step S206, the decoded response request ID 210A is compared with the response request ID 312A stored in the response request ID memory section 312 so as to determine whether or not the appropriate response request ID is present in the received signal. When the appropriate response request ID is determined to be absent (“NO”), the processing is terminated (step S207). When the appropriate response request ID is determined to be present (“YES”), the processing goes to step S208.

In step S208, the encryption section 316A encrypts the hash operation data H2 obtained in step S205 based on the secret key Ks specified in step S203. The encrypted hash operation data H2 is sent to the IC card 12A.

In step S209, the IC card 12A performs a hash operation using the random number D1 obtained in step S201 and the user's inherent information 218A stored in the user's inherent information memory section 218, and thus generates hash operation data H1.

In step S210, the encrypted hash operation data H2 received by the IC card 12A is decoded based on the public key Kp by the decoding section 216A, and thus hash operation data H3 is obtained.

In step S211, the hash operation data H1 generated in step S209 is compared with the hash operation data H3 obtained in step S210. When the hash operation data H1 matches the hash operation data H3 (“YES”), the processing goes to step S212, where the authenticity of the user is confirmed.

When the hash operation data H1 does not match the hash operation data H3 (“NO”) in step S210, the processing goes to step S213, where the authenticity of the user is rejected.

According to the above described encryption technology, management of abandoned keys is important. In the second example, the user's inherent information is used, so that the frequency at which keys are abandoned is reduced. For example, when the electronic seal 16A is lost, a newly issued electronic seal 16A can be structured so as to have the identical key. In this case, the security can be guaranteed merely by changing the user's inherent information 218A registered in the user's inherent information memory section 218. For example, even if an identical key is used by a plurality of users of, for example, the same family, the user can be specified by the user's inherent information. Therefore, the number of keys which are abandoned can be reduced. The registered user's inherent information is electronic data (digital data). Even if the information is physically the same as in the case of voiceprint, the information registered as digital data is different each time it is registered. Therefore, there is no lack of inherent information.

In the second example, authentication is performed between the IC card 12A and the electronic seal 16A. For performing authentication using the electronic seal 16A at the counter of a governmental office or the like, a personal computer for authentication can be used instead of the IC card 12A. When the electronic seal 16A is confirmed to be authentic, the user's inherent information is displayed on a display of the personal computer. The operator uses the user's inherent information so as to visually confirm the authenticity of the user.

As described in the above examples, the security level of authentication can be significantly improved using an electronic seal according to the present invention.

Authentication using an electronic seal according to the present invention can be performed, for example, as follows. A public key and a secret key usable for the public key cryptosystem are created. The public key is made public to a card company requiring authentication, a business operator with whom electronic commerce will be conducted, and other related parties. The secret key is confined in the electronic seal and the electronic seal is distributed to persons who wish to have the secret key. The electronic seal is usable in a same way as a registered seal.

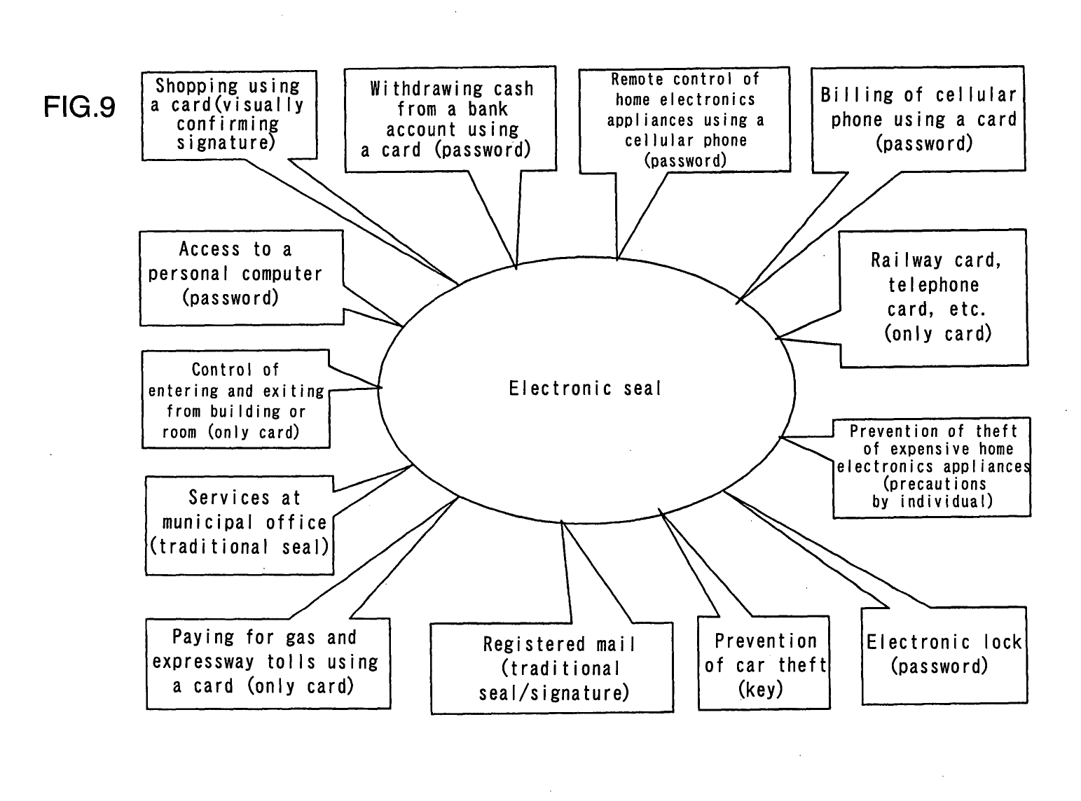

FIG. 9 shows various fields in which an electronic seal according to the present invention is applicable. Corresponding conventional methods of authentication are indicated in parentheses.

Conventionally, for shopping using a card, authentication is performed by visually confirming the signature. For withdrawal of cash from a bank account using a card, for remote control of home electronics appliances using a cellular phone or the like, for billing of cellular phone or the like using a card, for accessing a personal computer, and for opening an electronic lock, authentication is performed by inputting a password. For managing entering and exiting from a building or a room, for paying for gas and expressway tolls, and for paying for train fares and pay phones, authentication is performed by the card itself. The possess or of the card is determined to be the authentic user of the card. For preventing car theft, authentication is performed by the car key. The possessor of the car key is determined to be the authentic user of the car. At the counter of a municipal office of the like, authentication is performed by a traditional seal. When receiving registered mail, authentication is performed by a traditional seal or signature. Preventing theft of expensive home electronics appliances relies on the precautions of each individual. No authentication is required to permit the use thereof.

In these fields, an electronic seal according to the present invention can be combined with the conventional method of authentication. Thus, the security level can be significantly improved without putting any burden on the user. Loss of a password is difficult to notice unless damage is caused. Loss of the electronic seal according to the present invention is easily noticed when stolen, and thus measures against damage can be taken quickly. Mere loss of an electronic seal is unlikely to cause any damage.

Conventionally, a traditional seal is used for authentication at the counter of a municipal office or the like or for authentication when receiving registered mail. Considering that the digital government will be realized in the future in which information on each individual will be formed into electronic data and information and services are provided and also the rights and duties of each individual are managed using the electronic data, use of an electronic seal according to the present invention instead of the traditional seal is very effective.

Expensive home electronics appliances, when provided with an authentication function, are prevented from being used after being stolen. Electronic devices such as TVs, refrigerators, video apparatuses, and cameras can be provided with an authentication function such that authentication using the electronic seal is required before operating these devices. Thus, these devices do not operate without the electronic seal. Such a function is effective in tough neighborhood.

IC cards such as train passes can be provided with an authentication function using an electronic seal according to the present invention. Thus, the IC card alone does not function. Therefore, it is expected that more people will report the cards to the police or other authorities when they find them.

As described above, the present invention provides an electronic seal for realizing encryption and decryption based on a secret key, and thus significantly improves the security level without putting any burden on the user.

In the case where the user's inherent information such as signature, fingerprint, voiceprint, retina pattern, and photo of the user's face is made into the form of electronic data, and the electronic data is received and transmitted for authentication using an encryption technology, the security level of authentication can be significantly improved.

The electronic seal, when attached to, for example, fashion accessories such as rings, bracelets, earrings or the like, or glasses, which can be constantly worn by the user, is unlikely to be lost. Thus, the security level is further improved. Loss of an electronic seal is easily noticed if it is lost or stolen. Therefore, measures against damage can be taken sooner than when immaterial passwords are used.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An electronic seal, comprising:
an input section for inputting a random number encrypted based on a prescribed key;
a secret key memory section for storing a secret key related to the prescribed key;
a decoding section for decoding the input random number based on the secret key;
an encryption section for encrypting the decoded random number based on the secret key; and
an output section for outputting the random number encrypted based on the secret key.

2. An electronic seal according to claim 1, wherein:
when the input section inputs a first response request ID encrypted based on the prescribed key, the decoding section decodes the input first response request ID based on the secret key,
the electronic seal further includes a response request ID memory section for storing a second response request ID, and a comparison section for comparing the decoded first response request ID and the second response request ID, and
when the decoded first response request ID matches the second response request ID, the encryption section encrypts the decoded random number.

3. An electronic seal according to claim 1, wherein:
the secret key memory section stores a plurality of secret keys respectively corresponding to a plurality of card company ID numbers, and
when the input section inputs a card company ID number, the secret key memory section specifies the secret key corresponding to the input card company ID number among the plurality of secret keys.

4. An electronic seal according to claim 1, wherein the prescribed key is a public key, and the secret key and the public key form a key pair via a prescribed function.

5. A mobile device including an electronic seal according to claim 1.

6. An IC card, comprising:
a random number generation section for generating a random number;
a prescribed key memory section for storing a prescribed key;
an encryption section for encrypting the generated random number based on the prescribed key;
an output section for outputting the random number encrypted based on the prescribed key;
an input section for inputting a random number encrypted based on a secret key related to the prescribed key;
a decoding section for decoding the input random number based on the prescribed key; and
a comparison section for comparing the random number generated by the random number generation section and the decoded random number.

7. An IC card according to claim 6, further comprising an authentication section for, when the random number generated by the random number generation section matches the decoded random number, authenticating the user; and when the random number generated by the random number generation section does not match the decoded random number, rejecting the user.

8. An IC card according to claim 6, further comprising a response request ID memory section for storing a response request ID, wherein:
the encryption section encrypts the response request ID based on the prescribed key, and
the output section outputs the encrypted response request ID.

9. An IC card according to claim 6, further comprising a card company ID number memory section for storing a card company ID number, wherein the output section outputs the card company ID number.

10. An IC card according to claim 6, wherein the prescribed key memory section stores a plurality of prescribed keys respectively corresponding to a plurality of card company ID numbers.

11. An IC card according to claim 6, wherein the prescribed key is a public key, and the secret key and the public key form a key pair via a prescribed function.

12. An authentication system comprising:
an IC card, and
an electronic seal,
wherein:
the IC card includes:
a random number generation section for generating a random number,
a prescribed key memory section for storing a prescribed key,
a first encryption section for encrypting the generated random number based on the prescribed key, and
a first output section for outputting the random number encrypted based on the prescribed key;
the electronic seal includes:
a second input section for inputting the random number encrypted based on the prescribed key,
a secret key memory section for storing a secret key related to the prescribed key,
a second decoding section for decoding, based on the secret key, the random number encrypted based on the prescribed key,
a second encryption section for encrypting, based on the secret key, the random number decoded based on the secret key, and
a second output section for outputting the random number encrypted based on the secret key;
the IC card further includes:
a first input section for inputting the random number encrypted based on the secret key,
a first decoding section for decoding, based on the prescribed key, the random number encrypted based on the secret key, and
a comparison section for comparing the random number generated by the random number generation section and the random number decoded based on the prescribed key; and
the IC card and the electronic seal mutually exchange data for performing authentication.

13. An authentication system according to claim 12, wherein the IC card further includes an authentication section for, when the random number generated by the random number generation section matches the random number decoded based on the prescribed key, authenticating the user; and when the random number generated by the random number generation section does not match the random number decoded based on the prescribed key, rejecting the user.

14. An authentication system according to claim 12, wherein the prescribed key is a public key, and the secret key and the public key form a key pair via a prescribed function.

15. An electronic seal, comprising:
an input section for inputting a random number encrypted based on a prescribed key;
a secret key memory section for storing a secret key related to the prescribed key;
a decoding section for decoding the input random number based on the secret key;
a user's inherent information memory section for storing a user's inherent information;
a hash operation section for performing a hash operation using the decoded random number and the user's inherent information so as to output a hash operation result;
an encryption section for encrypting the hash operation result based on the secret key; and
an output section for outputting the encrypted hash operation result.

16. An electronic seal according to claim 15, wherein:
when the input section inputs a first response request ID encrypted based on the prescribed key, the decoding section decodes the input first response request ID based on the secret key, the electronic seal further includes a response request ID memory section for storing a second response request ID, and a comparison section for comparing the decoded first response request ID and the second response request ID, and
when the decoded first response request ID matches the second response request ID, the encryption section encrypts the hash operation result.

17. An electronic seal according to claim 15, wherein:
the secret key memory section stores a plurality of secret keys respectively corresponding to a plurality of card company ID numbers, and
when the input section inputs a card company ID number, the secret key memory section specifies the secret key corresponding to the input card company ID number among the plurality of secret keys.

18. An electronic seal according to claim 15, wherein the prescribed key is a public key, and the secret key and the public key form a key pair via a prescribed function.

19. A mobile device including an electronic seal according to claim 15.

20. An IC card, comprising:
a random number generation section for generating a random number;
a prescribed key memory section for storing a prescribed key;
an encryption section for encrypting the generated random number based on the prescribed key;
an output section for outputting the encrypted random number;
a user's inherent information memory section for storing user's inherent information;
a hash operation section for performing a hash operation using the generated random number and the user's inherent information so as to output a first hash operation result;
an input section for inputting a second hash operation result encrypted based on a secret key related to the prescribed key;
a decoding section for decoding the input second hash operation result based on the prescribed key; and
a comparison section for comparing the first hash operation result output from the hash operation section and the decoded second hash operation result.

21. An IC card according to claim 20, further comprising an authentication section for, when the first hash operation result output from the hash operation section matches the decoded second hash operation result, authenticating the user; and when the first hash operation result output from the hash operation section does not match the decoded second hash operation result, rejecting the user.

22. An IC card according to claim 20, further comprising a response request ID memory section for storing a response request ID, wherein:
the encryption section encrypts the response request ID based on the prescribed key, and
the output section outputs the encrypted response request ID.

23. An IC card according to claim 20, further comprising a card company ID number memory section for storing a card company ID number, wherein the output section outputs the card company ID number.

24. An IC card according to claim 20, wherein the prescribed key memory section stores a plurality of prescribed keys respectively corresponding to a plurality of card company ID numbers.

25. An IC card according to claim 20, wherein the prescribed key is a public key, and the secret key and the public key form a key pair via a prescribed function.

26. An authentication system comprising:
an IC card, and
an electronic seal,
wherein:
the IC card includes:
a random number generation section for generating a random number,
a prescribed key memory section for storing a prescribed key,
a first encryption section for encrypting the generated random number based on the prescribed key,
a first output section for outputting the encrypted random number,
a first user's inherent information memory section for storing a user's inherent information, and
a first hash operation section for performing a hash operation using the user's inherent information stored in the first user's inherent information memory section and the generated random number so as to output a first hash operation result;
the electronic seal includes:
a second input section for inputting the encrypted random number,
a secret key memory section for storing a secret key related to the prescribed key,
a second decoding section for decoding, based on the secret key, the encrypted random number,
a second user's inherent information memory section for storing user's inherent information,
a second hash operation section for performing a hash operation using the user's inherent information stored in the second user's inherent information memory section and the decoded random number so as to output a second hash operation result,
a second encryption section for encrypting the second hash operation result based on the secret key, and
a second output section for outputting the encrypted second hash operation result;
the IC card further includes:
a first input section for inputting the encrypted second hash operation result,
a first decoding section for decoding, based on the prescribed key, the encrypted second hash operation result,
a comparison section for comparing the first hash operation result and the decoded second hash operation result; and
the IC card and the electronic seal mutually exchange data for performing authentication.

27. An authentication system according to claim 26, wherein the IC card further includes an authentication section for, when the first hash operation result matches the decoded second hash operation result, authenticating the user; and when the first hash operation result does not match the decoded second hash operation result, rejecting the user.

28. An authentication system according to claim 26, wherein the prescribed key is a public key, and the secret key and the public key form a key pair via a prescribed function.
